(19) United States
(12) Patent Application Publication
(10) Pub. No.: US 2021/0179289 A1
(43) Pub. Date: Jun. 17, 2021

(54) AERIAL VEHICLE, COMMUNICATION TERMINAL AND NON-TRANSITORY COMPUTER-READABLE MEDIUM

(71) Applicant: KYOCERA Corporation, Kyoto (JP)

(72) Inventors: Shigeki TANABE, Yokohama-shi (JP); Yasuhiro UENO, Yokohama-shi (JP); Hideki MORITA, Yokohama-shi (JP); Isao MASUIKE, Tokyo (JP); Koutaro YAMAUCHI, Yokohama-shi (JP); Manabu SAKUMA, Yokohama-shi (JP); Kenji SHIMADA, Yokohama-shi (JP)

(73) Assignee: KYOCERA Corporation, Kyoto (JP)

(21) Appl. No.: 17/162,596

(22) Filed: Jan. 29, 2021

Related U.S. Application Data
(62) Division of application No. 16/741,848, filed on Jan. 14, 2020.
Application No. 16/741,848 is a continuation of application No. PCT/JP2018/026029, filed on Jul. 10, 2018.

(30) Foreign Application Priority Data
Jul. 27, 2017 (JP) 2017-145876

(51) Int. Cl. B64D 45/00; B64D 31/06; G08G 5/00

(52) U.S. Cl. CPC B64D 45/00; B64D 31/06; G08G 5/0013; B64D 2045/0085; B64C 2201/027; B64C 2201/122; G08G 5/0069

(57) ABSTRACT

An aerial vehicle includes at least one communicator and a controller. The controller is configured to cause the at least one communicator to transmit first information pertaining to a transportation system to at least one of a vehicle and a roadside device by controlling the at least one communicator.

### CROSS-REFERENCE TO RELATED APPLICATION

This present application is a Divisional of U.S. patent application Ser. No. 16/741,848 filed on Jan. 14, 2020, which is a Continuation Application of International Application No. PCT/JP2018/026029 filed on Jul. 10, 2018, which claims the benefit of Japanese Patent Application No. 2017-145876, filed on Jul. 27, 2017, the entire contents of which are incorporated herein by reference.

### TECHNICAL FIELD

The present disclosure relates to an aerial vehicle, a communication terminal and a non-transitory computer-readable medium.

### BACKGROUND

A configuration to acquire information with an unmanned aerial vehicle, such as a drone equipped with a camera or the like, is known.

### SUMMARY

An aerial vehicle according to the present disclosure comprises at least one communicator and a controller. The controller is configured to cause the at least one communicator to transmit first information pertaining to a transportation system to at least one of a vehicle and a roadside device by controlling the at least one communicator.

### BRIEF DESCRIPTION OF THE DRAWINGS

In the accompanying drawings:

FIG. 1 is a block diagram illustrating an example configuration of a communication system according to an embodiment;

FIG. 2 is a perspective view illustrating an example configuration of an unmanned aerial vehicle according to an embodiment;

FIG. 3 is a block diagram illustrating an example configuration of a communication terminal according to an embodiment;

FIG. 4 is a block diagram illustrating an example connection for communication between a vehicle and a communication system;

FIG. 5 is a block diagram illustrating an example connection for communication with a roadside device;

FIG. 6 is a block diagram illustrating an example in which the communication system substitutes for the roadside device;

FIG. 7 is a plan view illustrating an example configuration of a communication terminal according to an embodiment;

FIG. 8 is a flowchart illustrating an example of procedures executed by the communication terminal; and

FIG. 9 is a flowchart illustrating an example of procedures executed by the unmanned aerial vehicle.

### DETAILED DESCRIPTION

The information acquired by the unmanned aerial vehicle is not transmitted to vehicles or the like included in a transportation system.

It would therefore be helpful to provide an unmanned aerial vehicle, a communication terminal, a communication system, and a program that can improve the safety of a transportation system.

An unmanned aerial vehicle, a communication terminal, a communication system, and a program according to embodiments of the present disclosure can improve the safety of a transportation system.

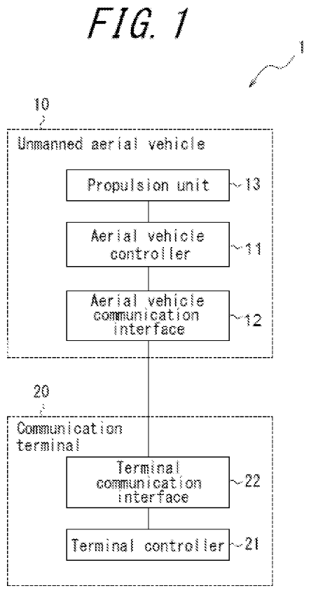

An example configuration of a communication system 1 is described. As illustrated in FIG. 1, the communication system 1 according to an embodiment includes an unmanned aerial vehicle 10 and a communication terminal 20. The unmanned aerial vehicle 10 includes an aerial vehicle controller 11, an aerial vehicle communication interface 12, and a propulsion unit 13. The communication terminal 20 includes a terminal controller 21 and a terminal communication interface 22. The aerial vehicle controller 11 and the aerial vehicle communication interface 12 are also respectively referred to as the controller and the communication interface of the unmanned aerial vehicle 10. The terminal controller 21 and the terminal communication interface 22 are also respectively referred to as the controller and the communication interface of the communication terminal 20. The unmanned aerial vehicle 10 and the communication terminal 20 can communicate with each other through the respective communication interfaces over a wired or wireless connection.

The aerial vehicle controller 11 connects to the components of the unmanned aerial vehicle 10, can acquire information from the components, and can control the components. The aerial vehicle controller 11 may acquire information from the communication terminal 20 and transmit information to the communication terminal 20 through the aerial vehicle communication interface 12. The aerial vehicle controller 11 may acquire information from an external apparatus, such as a server, and transmit information to the external apparatus through the aerial vehicle communication interface 12. The aerial vehicle controller 11 may control the propulsion unit 13 on the basis of acquired information.

The aerial vehicle controller 11 may include one or more processors. The term “processor” encompasses universal processors that execute particular functions by reading particular programs and dedicated processors that are specialized for particular processing. The dedicated processor may include an application specific integrated circuit (ASIC) for a specific application. The processor may include a programmable logic device (PLD). The PLD may include a field-programmable gate array (FPGA). The aerial vehicle controller 11 may be either a system-on-a-chip (SoC) or a system in a package (SiP) with one processor or a plurality of processors that work together. The aerial vehicle controller 11 may include a memory and store various information, programs for operating the components of the unmanned aerial vehicle 10, and the like in the memory. The memory may, for example, be a semiconductor memory. The memory may function as a working memory of the aerial vehicle controller 11.

The aerial vehicle communication interface 12 may include a communication device. The communication device may, for example, be a communication interface for a local area network (LAN) or the like. The aerial vehicle communication interface 12 may connect to a network through a communication interface for a LAN, cellular communication, or the like. The aerial vehicle communication interface 12 may connect to an external apparatus, such as a server, through the network. The aerial vehicle communication interface 12 may be configured to be capable of communicating with an external apparatus without going through a network.

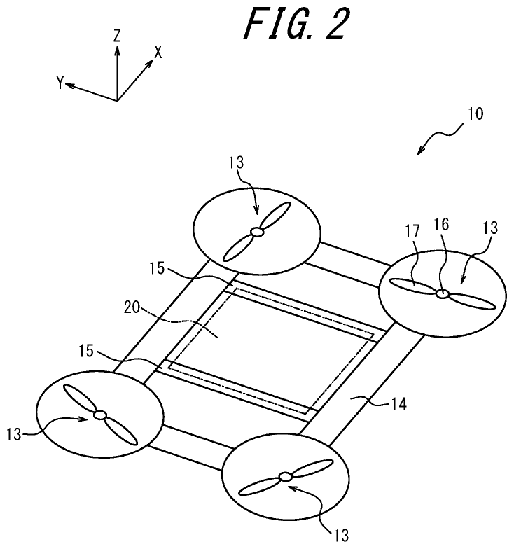

As illustrated in FIG. 2, the unmanned aerial vehicle 10 may further include a frame 14. The frame 14 may, for example, have a polygonal shape. The frame 14 may also have any other shape. The aerial vehicle controller 11 and the aerial vehicle communication interface 12 may be located in any portion of the frame 14. The propulsion unit 13 may be located at the apex of the frame 14 when the frame 14 has a polygonal shape. The propulsion unit 13 may be located in any portion of the frame 14. The frame 14 may include a holder 15. The holder 15 can hold the communication terminal 20, as indicated by the dashed-dotted virtual lines. In other words, the communication terminal 20 can be mounted on the unmanned aerial vehicle 10 via the holder 15. The communication terminal 20 can function as a portion of the communication system 1 even when not mounted on the unmanned aerial vehicle 10.

The propulsion unit 13 may, for example, be configured as a propeller 17 that is rotated by a motor 16. The propeller 17 may include a vane. The vane is also referred to as a blade. The number of vanes in the propeller 17 is not limited to two. One vane, or three or more vanes, may be included. The number of propulsion units 13 is not limited to four. Three or fewer, or five or more, propulsion units 13 may be included. The propulsion unit 13 may acquire a control instruction for the motor 16 from the aerial vehicle controller 11. By controlling the motor 16 on the basis of the control instruction, the propulsion unit 13 can cause the unmanned aerial vehicle 10 to float, control the orientation of the unmanned aerial vehicle 10, and move the unmanned aerial vehicle 10. The control instruction may be generated by the aerial vehicle controller 11 or by the terminal controller 21 of the communication terminal 20.

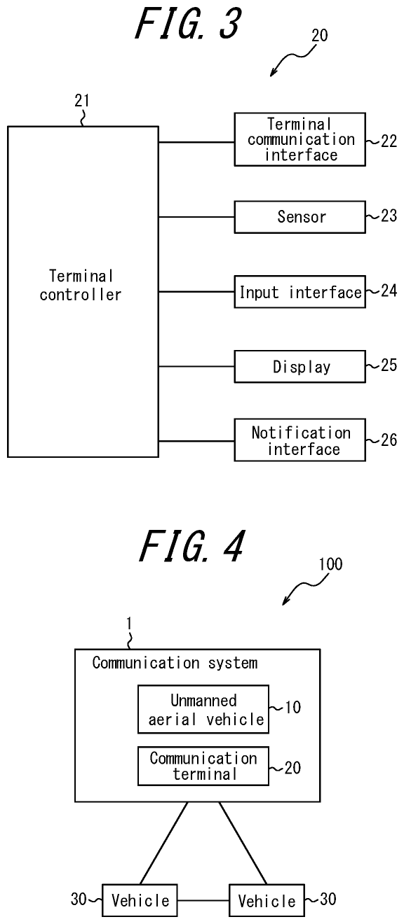

As illustrated in FIG. 3, the communication terminal 20 may further include a sensor 23, an input interface 24, a display 25, and a notification interface 26. The terminal controller 21 connects to the components of the communication terminal 20, can acquire information from the components, and can control the components. When the communication terminal 20 is mounted on the unmanned aerial vehicle 10, the terminal controller 21 may transmit information for controlling the propulsion unit 13 of the unmanned aerial vehicle 10 to the aerial vehicle controller 11. In other words, when the communication terminal 20 is mounted on the unmanned aerial vehicle 10, the propulsion unit 13 may be controlled by at least one of the aerial vehicle controller 11 and the terminal controller 21. The terminal controller 21 may be configured to be identical or similar to the aerial vehicle controller 11. The terminal communication interface 22 may be configured to be identical or similar to the aerial vehicle communication interface 12.

The sensor 23 may include a six-axis motion sensor for measuring each of acceleration and angular velocity along three axes. The sensor 23 may include a position sensor for acquiring the position of the communication terminal 20 on the basis of a global positioning system (GPS), a global navigation satellite system (GNSS), or the like. The position sensor may acquire the position of the communication terminal 20 on the basis of the radio field intensity of a wireless LAN or the like. The sensor 23 may include a human sensor that senses the presence of a human. The sensor 23 may include a distance sensor that measures the distance to a human or an object, such as a vehicle, with any of various methods such as time of flight (ToF). The sensor 23 may include a touch sensor or a proximity sensor. The touch sensor may detect contact by an object with any system, such as a capacitive system, a resistive film system, a surface acoustic wave system, an ultrasonic wave system, an infrared system, an electromagnetic induction system, a load detection system, or the like. The proximity sensor may detect proximity of an object with any system, such as a capacitive system, an ultrasonic wave system, an infrared system, or an electromagnetic induction system. The sensor 23 may include a variety of sensors, such as a strain sensor, a barometric pressure sensor, or an illuminance sensor.

The input interface 24 may include an input device, such as physical keys or a touch panel. The input interface 24 may include an imaging device, such as a camera, and incorporate captured images. The imaging device may, for example, be a complementary metal oxide semiconductor (CMOS) image sensor, a charge coupled device (CCD), or the like. The input interface 24 may include an audio input device, such as a microphone, and capture audio data.

The communication terminal 20 may identify the position of the communication terminal 20 using an imaging device to replace, or supplement, the position sensor. Specifically, the communication terminal 20 may acquire, from the imaging device, a scenery image that includes buildings, facilities, traffic lights, signs, posters, plants, or the like around the communication terminal 20. The communication terminal 20 may perform image analysis on the acquired scenery image and identify the position of the communication terminal 20 on the basis of characteristics identified by the image analysis. The communication terminal 20 is, for example, connectable to a known communication network, such as 2G, 3G, 4G, or 5G. To acquire position information matching the characteristics that the communication terminal 20 identified by image analysis, the communication terminal 20 may communicate over a known network with a cloud server that associates and manages position information, such as latitude and longitude, with characteristics of scenery images corresponding to the position information. The communication terminal 20 may identify the position of the communication terminal 20 on the basis of the position information acquired from the cloud server.

The display 25 may, for example, include a liquid crystal display device, electro-luminescence (EL) display device, inorganic EL display device, light emission diode (LED) display device, or the like. The display 25 may include a device that projects an image, such as a projector.

The notification interface 26 may include an audio output device, such as a speaker. The notification interface 26 may include a vibration device configured with a vibration motor, a piezoelectric element, or the like. The notification interface 26 may include a tactile sensation providing device that provides a tactile sensation to the user by transmitting vibration, generated by a vibration device or the like, to the user's body. The notification interface 26 may include a variety of light-emitting devices, such as a lamp, a flashlight, an LED, or a revolving light.

The sensor 23, input interface 24, display 25, and notification interface 26 may each be included in at least one of the unmanned aerial vehicle 10 and the communication terminal 20. In other words, the communication system 1 may include at least one of the sensor 23, input interface 24, display 25, and notification interface 26.

At least one of the unmanned aerial vehicle 10 and the communication terminal 20 may further include a battery. In other words, the communication system 1 may further include a battery. When the communication terminal 20 is mounted on the unmanned aerial vehicle 10, the unmanned aerial vehicle 10 may receive supply of power from the battery of the communication terminal 20. When the communication terminal 20 is mounted on the unmanned aerial vehicle 10, the communication terminal 20 may receive supply of power from the battery of the unmanned aerial vehicle 10.

The communication system 1 may include a motion sensor as the sensor 23 of at least one of the unmanned aerial vehicle 10 and the communication terminal 20. The motion sensor may detect the position or orientation, or change thereof, of the unmanned aerial vehicle 10. The motion sensor may detect the position or orientation, or change thereof, of the communication terminal 20. The communication system 1 may generate a control instruction for the propulsion unit 13 on the basis of the detection result from the motion sensor related to at least one of the unmanned aerial vehicle 10 and the communication terminal 20. The control instruction for the propulsion unit 13 may be generated by at least one of the aerial vehicle controller 11 and the terminal controller 21.

The holder 15 of the unmanned aerial vehicle 10 may be configured to be capable of changing the orientation of the communication terminal 20. The holder 15 may, for example, be configured to be capable of rotating the communication terminal 20 with the X-axis or Y-axis as the axis of rotation. The holder 15 may, for example, include a drive mechanism such as a stepping motor. The holder 15 may acquire a control instruction related to the orientation of the communication terminal 20 from the aerial vehicle controller 11 and change the orientation of the communication terminal 20 on the basis of the control instruction. In other words, the aerial vehicle controller 11 may control the holder 15 to change the orientation of the communication terminal 20.

The sensor 23 or the input interface 24 may be configured to detect the position of the user's eyes. The aerial vehicle controller 11 may acquire information on the detected position of the user's eyes directly from the sensor 23 or the input interface 24, or from the communication terminal 20 through the aerial vehicle communication interface 12. The aerial vehicle controller 11 may generate a control instruction related to the orientation of the communication terminal 20 on the basis of the positional relationship between the user's eyes and the unmanned aerial vehicle 10. The aerial vehicle controller 11 may acquire a control instruction related to the orientation of the communication terminal 20 from the communication terminal 20. The display 25 can become visible to the user by the orientation of the communication terminal 20 being controlled on the basis of the position of the user's eyes.

The change in the orientation of the communication terminal 20 may be detected by the sensor 23 when the sensor 23 includes a motion sensor. The change in the orientation of the communication terminal 20 may be calculated on the basis of control data of the holder 15. The aerial vehicle controller 11 or the terminal controller 21 may change the control of the propulsion unit 13 of the unmanned aerial vehicle 10 on the basis of the change in the orientation of the communication terminal 20.

At least a portion of the functions of the aerial vehicle controller 11 and the terminal controller 21 may be exchanged, with the controllers being configured to perform the exchanged functions. At least a portion of the functions of the aerial vehicle communication interface 12 and the terminal communication interface 22 may be exchanged, with the communication interfaces being configured to perform the exchanged functions. In other words, the communication system 1 may be configured for execution of the functions of the unmanned aerial vehicle 10 and the communication terminal 20 as a whole.

An example configuration of a transportation system 100 (see FIG. 4) is now described. The communication system 1, which includes the unmanned aerial vehicle 10 and the communication terminal 20, may move so as to follow the user of the communication terminal 20, who is a pedestrian, by controlling flight of the unmanned aerial vehicle 10. The pedestrian can be included as an element of the transportation system 100. The communication system 1 that follows the pedestrian can be included as an element of the transportation system 100.

Unlike a configuration whereby the unmanned aerial vehicle 10 merely acquires information on its surroundings, the communication system 1 according to the present disclosure can move to follow the user and also provide notification on the basis of acquired information. This approach allows provision of notification easily perceived by the user. When the notification from the communication system 1 is information related to user safety in the transportation system 100, user safety can be improved by the information being easily perceived by the user.

Unlike a configuration whereby the unmanned aerial vehicle 10 merely acquires information on its surroundings, the communication system 1 according to the present disclosure can output the acquired information to elements included in the transportation system 100. With this approach, the information acquired by the communication system 1 can contribute to improving the safety of the transportation system 100 overall.

The communication system 1 can acquire information pertaining to the transportation system 100 from each element included in the transportation system 100. Information related to user safety in the transportation system 100 is also referred to as safety information. The information pertaining to the transportation system 100 may include safety information. The communication system 1 may detect conditions surrounding the communication system 1 using the constituent elements of the unmanned aerial vehicle 10 or the communication terminal 20. The communication system 1 may output the information related to the surrounding conditions by transmitting the information to other elements in the transportation system 100. The information pertaining to the transportation system 100 may include information related to the surrounding conditions of the communication system 1 detected by the communication system 1. The communication system 1 may detect the movement, state, or the like of the user of the communication terminal 20 and output this information as information pertaining to the transportation system 100.

As illustrated in FIG. 4, the communication system 1 may be capable of communicating with vehicles 30 that can be included as an element of the transportation system 100. The communication between the communication system 1 and the vehicles 30, and the communication between vehicles 30, may be wireless. The communication system 1 may be capable of communicating with another communication system 1. The communication system 1 may be capable of communicating with the vehicles 30 or another communication system 1 via at least one of the aerial vehicle communication interface 12 and the terminal communication interface 22. The vehicle 30 may include a camera, a distance sensor, or the like. The vehicle 30 may transmit information pertaining to the surrounding conditions imaged by the camera to the communication system 1, to another vehicle 30, or the like. The vehicle 30 may transmit position information of a pedestrian, another vehicle 30, or the like detected by the distance sensor to the communication system 1, to another vehicle 30, or the like. The vehicle 30 is not limited to including a camera or a distance sensor and may include a different structure for acquiring information on the surroundings.

The vehicle 30 may warn the driver of the vehicle 30 about another vehicle 30, a pedestrian, or the like on the basis of communication with another vehicle 30 or the communication system 1. The vehicle 30 may be controlled automatically on the basis of communication with another vehicle 30 or the communication system 1. The communication system 1, which moves to follow a pedestrian, may warn the pedestrian of a vehicle 30 or the like or notify the pedestrian of safety information on the basis of communication with another communication system 1 or the vehicle 30. The communication system 1 may, for example, warn the pedestrian or notify the pedestrian of safety information by moving the unmanned aerial vehicle 10 into the pedestrian's field of vision. The communication system 1 may warn the pedestrian or notify the pedestrian of safety information by displaying information on the display 25. The communication system 1 may warn the pedestrian or notify the pedestrian of safety information by outputting audio, emitting light, or generating vibration with the notification interface 26. In other words, the communication system 1 may output information pertaining to the transportation system 100, in which the user of the communication terminal 20 is included, to the user by a variety of methods.

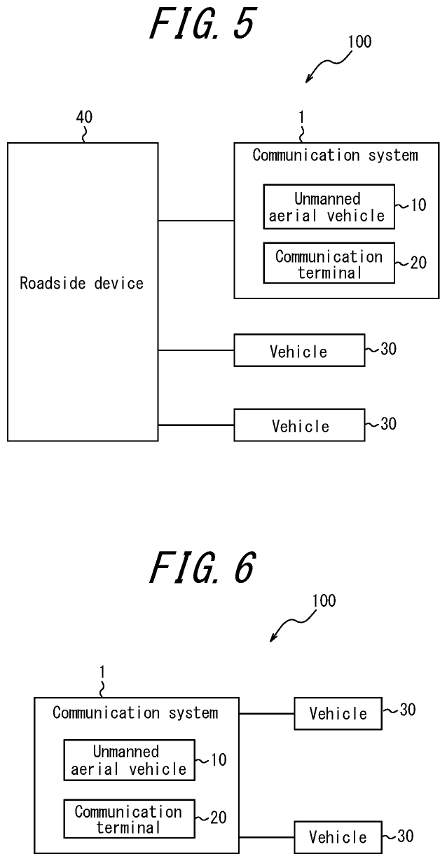

As illustrated in FIG. 5, the transportation system 100 can include a roadside device 40, installed on the roadside or the like, as an element of the transportation system 100. The communication system 1 and the vehicle 30 may be capable of communicating with the roadside device 40. The roadside device 40 may communicate with the communication system 1 and the vehicle 30 wirelessly. The roadside device 40 may include a camera, a distance sensor, or the like. The roadside device 40 may transmit information pertaining to the surrounding conditions imaged by the camera to the communication system 1, the vehicle 30, or the like. The roadside device 40 may transmit position information of a pedestrian, a vehicle 30, or the like detected by the distance sensor to the communication system 1, the vehicle 30, or the like. The roadside device 40 is not limited to including a camera or a distance sensor and may include a different configuration for acquiring information on the surroundings. The roadside device 40 may transmit information acquired by another configuration to the communication system 1, the vehicle 30, or the like. The roadside device 40 may transmit information acquired from the communication system 1 to another communication system 1 or the vehicle 30. The roadside device 40 may transmit information acquired from a vehicle 30 to another vehicle 30 or the communication system 1. On the basis of communication with the roadside device 40, the vehicle 30 may warn the driver of the vehicle 30 about another vehicle 30, a pedestrian, or the like or may be controlled automatically. The communication system 1, which moves to follow a pedestrian, may operate to warn the pedestrian about a vehicle 30 or the like on the basis of communication with the roadside device 40.

In the transportation system 100, the communication system 1 may substitute for at least a portion of the functions of the roadside device 40, as illustrated in FIG. 6. The communication system 1 may transmit information that is identical or similar to information that can be acquired by the roadside device 40 to another communication system 1, the vehicle 30, or the like. In other words, the communication system 1 may output information pertaining to the transportation system 100, in which the user of the communication terminal 20 is included, to another element in the transportation system 100.

In the examples illustrated in FIG. 4 through FIG. 6, the communication between elements included in the transportation system 100 is also referred to as vehicle to vehicle communication (V2V), vehicle to pedestrian communication (V2P), and vehicle to infrastructure communication (V2I). Vehicle to vehicle communication is communication between vehicles 30. Vehicle to pedestrian communication is communication between the vehicle 30 and the communication terminal 20 of a pedestrian. Vehicle to infrastructure communication is communication between the road, traffic lights, road signs, or the like and the vehicle 30. These types of communication can collectively be referred to as vehicle to everything (V2X) communication. V2X communication can form at least part of a system to support driving of the vehicles 30 in the transportation system 100. A system to support driving of vehicles 30 is also referred to as an intelligent transport system (ITS). The communication system 1 may output information pertaining to the transportation system 100, in which the user of the communication terminal 20 is included, by transmitting to various recipients through communication such as V2X communication.

The communication terminal 20 is configured to be capable of communicating with the unmanned aerial vehicle 10 through the communication interface. The communication terminal 20 may or may not be mounted on the unmanned aerial vehicle 10. In the examples in FIG. 4 through FIG. 6, the communication system 1 that includes the unmanned aerial vehicle 10 and the communication terminal 20 is included as an element of the transportation system 100. These examples are not limiting, and the unmanned aerial vehicle 10 and communication terminal 20 may be included independently as elements of the transportation system 100. In other words, the communication of the vehicle 30 or the roadside device 40 with the communication system 1 may be communication by the vehicle 30 or the roadside device 40 with the unmanned aerial vehicle 10 or communication by the vehicle 30 or the roadside device 40 with the communication terminal 20.

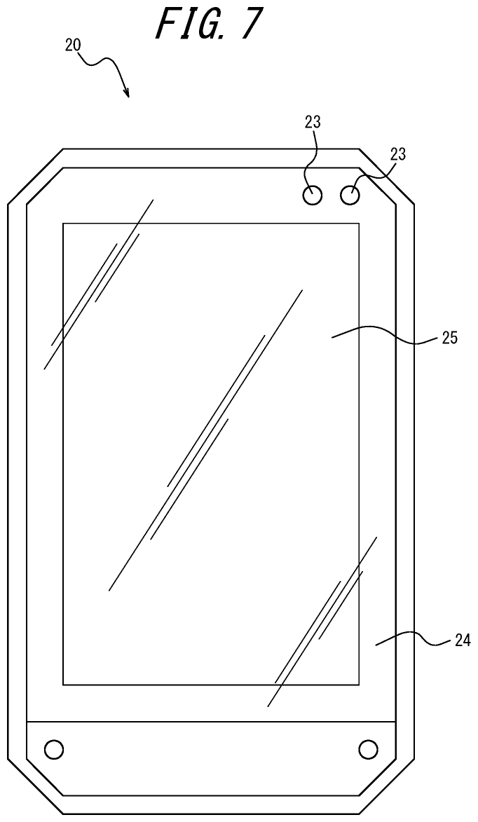

An example of operations of the communication terminal 20 is now described. As illustrated in FIG. 7, the communication terminal 20 may include a sensor 23, an input interface 24, and a display 25. The communication terminal 20 may, for example, be a smartphone provided with a touch panel as the input interface 24. The communication terminal 20 may be further provided with physical keys as the input interface 24. The communication terminal 20 is not limited to being a smartphone and may be a different type of terminal.

The communication terminal 20 may receive input on the basis of a press on a physical key or the like, or a touch or slide on the touch panel or the like. The communication terminal 20 may receive input on the basis of a gesture detected by a camera or the like. The communication terminal 20 may receive input on the basis of sound detected by a microphone or the like. The communication terminal 20 may receive input on the basis of the user's biological information detected by a sensor, camera, or the like. The user's biological information may include a variety of information, such as the user's face, fingerprint, vein pattern in the finger or palm, or iris pattern.

The communication terminal 20 can be mounted on the unmanned aerial vehicle 10. The unmanned aerial vehicle 10 with the communication terminal 20 mounted thereon can be caused to float by the propulsion unit 13. The communication system 1 that includes the unmanned aerial vehicle 10 and the communication terminal 20 can acquire the initial altitude at which the unmanned aerial vehicle 10 starts to float. The communication system 1 may acquire the altitude of the unmanned aerial vehicle 10 on the basis of barometric pressure detected by a barometric pressure sensor. The communication system 1 may acquire the altitude of the unmanned aerial vehicle 10 on the basis of position information calculated from the radio field intensity of a wireless LAN or the like or position information of a GPS, GNSS, or the like.

The communication terminal 20 may be configured so that the receivable operation input when the unmanned aerial vehicle 10 with the communication terminal 20 mounted thereon differs from the receivable operation input when the user holds the communication terminal 20. The communication terminal 20 may, for example, be configured to receive operation input by direct contact by the user when being held by the user and to be operable without direct contact by the user when floating. The communication terminal 20 may be configured to be operable without direct contact by the user by detecting the user's gesture, voice, biological information, or the like using a camera, microphone, sensor, or the like when the communication terminal 20 is mounted in the unmanned aerial vehicle 10 and is floating.

The communication terminal 20 can detect that the communication terminal 20 has been mounted on the unmanned aerial vehicle 10. The communication terminal 20 may, for example, include a terminal or sensor for electrically detecting mounting on the unmanned aerial vehicle 10. The communication terminal 20 may automatically detect mounting on the unmanned aerial vehicle 10 using the terminal or sensor. The communication terminal 20 may be set to the state of being mounted on the unmanned aerial vehicle 10 by user operation.

The communication terminal 20 may operate in various modes. The communication terminal 20 may, for example, operate in various modes such as normal mode allowing notification by audio and silent mode prohibiting notification by audio. When mounted on the unmanned aerial vehicle 10, the communication terminal 20 may transition to and operate in an aerial vehicle mounted mode.

The unmanned aerial vehicle 10 may fly at a distance from the user. The unmanned aerial vehicle 10 may fly at a position not visible to the user. The unmanned aerial vehicle 10 may fly back to a position visible to the user at a predetermined timing. The predetermined timing may, for example, be when the communication terminal 20 has an incoming phone call, e-mail, message, or the like. The predetermined timing may be when the communication system 1 acquires information of which the user is to be notified. The predetermined timing may be when the user calls to the communication system 1 through another device. The predetermined timing is not limited to these examples and may be any of various timings. The unmanned aerial vehicle 10 may identify a user and return to a position visible to the identified user. To identify the user, the unmanned aerial vehicle 10 may recognize the user's biological information or the like using a camera, sensor, or the like. The unmanned aerial vehicle 10 may detect a person using a device that does not identify the person, such as a human sensor, and certify whether the detected person is the user based on biological information or the like.

The unmanned aerial vehicle 10 may suspend the propulsion unit 13 upon being held by the user while floating. The unmanned aerial vehicle 10 may further include a configuration for detecting that the unmanned aerial vehicle 10 is held by the user. The unmanned aerial vehicle 10 may, for example, detect holding by the user with a sensor such as a capacitance sensor or pressure sensor, by pressing of a switch, or the like. The unmanned aerial vehicle 10 can be prevented from falling by suspension of the propulsion unit 13 after detection that the unmanned aerial vehicle 10 is held by the user.

When not held by the user, the unmanned aerial vehicle 10 may stop flight on the basis of a noncontact operation by the user. In this case, the unmanned aerial vehicle 10 may be controlled to stop after landing gently on the ground or the like to avoid a shock from falling.

An example of control to unlock the communication terminal 20 is now described. In a sleep state, or in a state in which at least a portion of operations are locked, the communication terminal 20 can transition to an awake or unlocked state by receiving predetermined input with the input interface 24. The sleep state, or the state in which at least a portion of operations are locked, is also referred to as a first state. The awake or unlocked state is also referred to as a second state. The predetermined input may, for example, be the press of a power key, input of a password or other character string to the input interface 24, or the user's biological information as read by the sensor 23. The predetermined input may be a gesture by the user detected by a camera or the like or the user's voice detected by a microphone or the like.

The communication terminal 20 may automatically transition from the first state to the second state when mounted on the unmanned aerial vehicle 10. The communication terminal 20 may also transition from the first state to the second state on the basis of user input, regardless of mounting on the unmanned aerial vehicle 10. The communication terminal 20 sometimes transitions to the first state while the unmanned aerial vehicle 10, on which the communication terminal 20 is mounted, is floating. In this case, the communication terminal 20 can be configured to allow the transition to the second state by an operation whereby the user does not directly contact the communication terminal 20 or the unmanned aerial vehicle 10. When floating, the communication terminal 20 may transition to the second state by, for example, authentication based on the user's face, iris, or the like, or detection of a user gesture, the user's voice, or the like. Allowing the communication terminal 20 to transition from the first state to the second state without the user directly contacting the communication terminal 20 or the unmanned aerial vehicle 10 can facilitate control of the orientation of the floating unmanned aerial vehicle 10 on which the communication terminal 20 is mounted.

The communication terminal 20 may transition automatically to the first state when not receiving operation input for a predetermined period of time. The communication terminal 20 may be configured not to transition automatically to the first state while in the state of being mounted on the unmanned aerial vehicle 10.

An example of control for an incoming phone call to the communication terminal 20 is now described. When the communication terminal 20 has an incoming phone call, the communication terminal 20 can take the phone call by user operation. The communication terminal 20 may take the phone call by a touch operation on the touch panel, a slide operation on the touch panel, pressing of a physical key pertaining to a phone call, or the like. The communication terminal 20 may take the phone call on the basis of a gesture by the user, the user's voice, or the like detected by a camera, microphone, or the like.

When the communication terminal 20 is mounted in the unmanned aerial vehicle 10, the unmanned aerial vehicle 10 may fly to a position visible to the user on the basis of an incoming phone call to the communication terminal 20. The communication terminal 20 may take the phone call when the unmanned aerial vehicle 10 is held by the user and stops or may take the phone call on the basis of a gesture by the user, the user's voice, or the like detected by a camera, microphone, or the like. When the communication terminal 20 takes a phone call while the unmanned aerial vehicle 10 is floating, noise generated by the propulsion unit 13 of the unmanned aerial vehicle 10 could be included in the audio transmitted to the other party. The communication terminal 20 may transmit audio with the noise canceled to the other party.

An example of control for charging of the communication terminal 20 is now described. The battery of the communication terminal 20 may be charged by being connected to a power source via a cable or the like, or may be charged by a wireless power supply. The battery of the communication terminal 20 may also be charged by the communication terminal 20 being placed in a cradle. When the communication terminal 20 is mounted in the unmanned aerial vehicle 10, the unmanned aerial vehicle 10 may fly to a position in which the battery of the communication terminal 20 is charged by a wireless power supply when the state of charge of the battery of the communication terminal 20 falls below a predetermined value. When the unmanned aerial vehicle 10 includes a battery, the battery of the unmanned aerial vehicle 10 may also be charged by a wireless power supply. The battery of the unmanned aerial vehicle 10 and the battery of the communication terminal 20 may be charged simultaneously. The battery of the unmanned aerial vehicle 10 and the battery of the communication terminal 20 may each have an antenna for receiving wireless power supply. The antennas of the unmanned aerial vehicle 10 and the communication terminal 20 may be configured not to overlap when the communication system 1 is placed in a cradle while the communication terminal 20 is mounted in the unmanned aerial vehicle 10. The shape of the cradle may be determined to reduce the difference between the distance from the antennas of the unmanned aerial vehicle 10 and the communication terminal 20.

An example of operations of the communication terminal 20 while the user is moving is now described. The communication terminal 20 can be set to a mode that does not output audio, such as silent mode, when the user of the communication terminal 20 is riding in a train, on an automobile, or the like. Floating of the unmanned aerial vehicle 10 can be prohibited when the communication terminal 20 is mounted in the unmanned aerial vehicle 10 while the user is riding in a train, on an automobile, or the like. The communication system 1 that includes the unmanned aerial vehicle 10 and the communication terminal 20 may detect that the user is riding in a train, on an automobile, or the like using the sensor 23. The sensor 23 can, for example, detect riding on a train, in an automobile, or the like on the basis of a vibration pattern. The sensor 23 can detect riding on a train by a change in geomagnetism detectable by a geomagnetic sensor and a change in acceleration detectable by an acceleration sensor. Floating of the unmanned aerial vehicle 10 may be prohibited on the basis of the detection result by the sensor 23. Floating of the unmanned aerial vehicle 10 may also be prohibited in a variety of other cases, such as when the user is walking or running, on the basis of user settings. The communication system 1 that includes the unmanned aerial vehicle 10 and the communication terminal 20 may, when judging that the user is moving, notify the user via the communication terminal 20 that floating of the unmanned aerial vehicle 10 is prohibited. Specifically, the communication terminal 20 may use the display 25 to display an image indicating that floating is prohibited or use the notification interface 26 to output audio indicating that floating is prohibited, to emit light, or to generate vibration.

When the user of the communication terminal 20 is walking, the communication terminal 20 can be set to a mode that does not accept operations while the user is walking. When the communication terminal 20 is mounted on the unmanned aerial vehicle 10 while the user is walking, the communication terminal 20 may operate in the aerial vehicle mounted mode. The unmanned aerial vehicle 10 may fly while following the user's steps. The communication terminal 20 operating in the aerial vehicle mounted mode may follow the user by flight of the unmanned aerial vehicle 10 even while the user is walking and may accept user operation. The unmanned aerial vehicle 10 may fly so as to guide the user to the user's destination. The communication system 1 may project an image or the like indicating the user's destination on the ground, for example. The communication system 1 may measure the distance to the user with the sensor 23 and fly so as to stay a predetermined distance from the user.

When the user of the communication terminal 20 is walking, the communication terminal 20 can count the user's steps on the basis of vibration detected by the sensor 23. When the communication terminal 20 is mounted on the unmanned aerial vehicle 10 while the user is walking, the communication terminal 20 cannot detect vibration produced by the user's walking. Instead of measuring the number of steps by detecting vibration, the communication terminal 20 can calculate the user's number of steps on the basis of the travel distance detected by a motion sensor, a position sensor, or the like and data on the user's step length.

Another example of operations of the communication terminal 20 while floating via the unmanned aerial vehicle 10 is now described. When the communication terminal 20 is mounted on the unmanned aerial vehicle 10 and is floating, the size of icons, characters, or the like displayed on the display 25 of the communication terminal 20 may be made larger than when the user is holding the communication terminal 20 by the hand. This configuration makes it easier for the user to see the display.

When the communication terminal 20 is mounted on the unmanned aerial vehicle 10 and is floating, the communication terminal 20 may increase the display size of a map as compared to when the user is holding the communication terminal 20 by the hand. The communication terminal 20 may switch the display format of the map from 2D to 3D. The communication terminal 20 may change the display format of the map to street view or the like. The communication system 1 may project the map onto the ground or the like in the case of a projector being included as the display 25. These display formats can make the map easier for the user to see.

When the communication terminal 20 is mounted on the unmanned aerial vehicle 10 and is floating, the communication terminal 20 may operate in the aerial vehicle mounted mode. The communication terminal 20 may be set automatically to output audio in the aerial vehicle mounted mode even if the communication terminal 20 was set to a mode that does not emit sound, such as silent mode, when the user was holding the communication terminal 20.

An example of operations by the communication system 1 is now described. The communication system 1 that includes the unmanned aerial vehicle 10 and the communication terminal 20 can operate in various ways in the transportation system 100.

An example of operations by the communication system 1 when the user approaches an intersection is described. The communication system 1 may detect that the user is approaching an intersection on the basis of information acquired from the roadside device 40. The communication system 1 may detect that the user is approaching an intersection on the basis of position information that can be acquired by the sensor 23 and map data. The communication system 1 may notify the user that the user is approaching an intersection.

The communication system 1 may detect that a vehicle 30 is approaching the user on the basis of information acquired from the roadside device 40 or the vehicle 30. The communication system 1 may notify the user that the vehicle 30 is approaching the user.

The approach of the user to an intersection and the approach of the vehicle 30 to the user can collectively be referred to as approach information. The approach information may form at least a portion of safety information related to the user included in the transportation system 100 as a pedestrian.

The communication system 1 may notify the user of the approach information by movement of the unmanned aerial vehicle 10. The communication system 1 may cause the unmanned aerial vehicle 10 to move to a position highly visible to the user. The communication system 1 may notify the user of the approach information by causing the unmanned aerial vehicle 10 to float in front of the user. In other words, the communication system 1 may cause the unmanned aerial vehicle 10 to float at a height corresponding to the height of the user's eyes and at a position located a predetermined distance away from the user's eyes. By causing the unmanned aerial vehicle 10 to float in front of the user, the communication system 1 can stop the user from walking and encourage the user to confirm the surrounding conditions. This can improve user safety in the transportation system 100.

The communication system 1 may cause the unmanned aerial vehicle 10 to make a predetermined movement. The predetermined movement may, for example, be a back-and-forth movement in the vertical or horizontal direction, or movement in various other patterns. The movement pattern of the unmanned aerial vehicle 10 may be associated with information of which the communication system 1 notifies the user. For example, a back-and-forth movement in the vertical direction may be associated with the approach information. This example is not limiting, and various movements may be associated with various information.

The communication system 1 may notify the user of various information, such as the approach information, by causing the unmanned aerial vehicle 10 to touch or collide with the user's body. The communication system 1 may notify the user of various information by causing the unmanned aerial vehicle 10 to approach the user's body enough for the user to feel the wind produced by the propulsion unit 13.

The communication system 1 may notify the user of the approach information using the display 25 or the notification interface 26. The communication system 1 may notify the user of the approach information using the display 25 or the notification interface 26 while causing the unmanned aerial vehicle 10 to move to a position highly visible to the user or causing the unmanned aerial vehicle 10 to make a predetermined movement.

When the unmanned aerial vehicle 10 is not floating, the communication system 1 may start floating of the unmanned aerial vehicle 10 in response to detection of the approach information. The unmanned aerial vehicle 10 may be tied to a portion of the user's body, or to a portion of the user's belongings, with a strap or the like so that the user can carry the communication system 1 while the unmanned aerial vehicle 10 is not floating. The communication system 1 that includes the unmanned aerial vehicle 10 may hang from the user's body or belongings by the strap or the like while the unmanned aerial vehicle 10 is not floating. Tying the unmanned aerial vehicle 10 with a strap or the like allows the distance between the communication system 1 and the user to be limited by the length of the strap or the like. This can prevent the communication system 1 from flying too far away. The unmanned aerial vehicle 10 may include a mechanism, such as a reel, for controlling the length of the strap or the like. The unmanned aerial vehicle 10 may control the distance from the user by controlling the length of the strap or the like. The communication system 1 may notify the user of various information, such as the approach information, by causing the unmanned aerial vehicle 10 to move so as to pull the user by the strap or the like.

The communication system 1 may transmit the approach information to the roadside device 40 or the vehicle 30. The communication system 1 can thus warn the vehicle 30. Consequently, the safety of the user as a pedestrian can be further improved.

While the user is walking as a pedestrian, the communication system 1 may cause the unmanned aerial vehicle 10 to fly so as to follow the user from a predetermined distance. The communication system 1 may cause the unmanned aerial vehicle 10 to fly so as to follow the user from the side or from behind. This makes it less likely that the unmanned aerial vehicle 10 will block the user's path. The communication system 1 may cause the unmanned aerial vehicle 10 to move ahead of the user when notifying the user of the approach information.

An example of operations by the communication system 1 on the road at night is now described. When the user is walking on the road at a time of day when it is difficult to perceive the surrounding conditions, or in a dark environment such as a tunnel, the communication system 1 may illuminate the user's surroundings or feet. This configuration can improve user safety. When an LED or a lamp is included as the display 25 or notification interface 26, for example, the communication system 1 may turn these on to illuminate the user's surroundings or feet. The communication system 1 may control the display 25 to face vertically downward to illuminate the user's surroundings or feet with light emitted from the display 25. When a projector is included as the display 25, the communication system 1 may illuminate the user's surroundings or feet using the light source of the projector. The communication system 1 may illuminate the user's surroundings or feet on the basis of time information stored in the communication terminal 20. The communication system 1 may detect the illuminance of the user's surroundings or by the user's feet when an illuminance sensor is included as the sensor 23. The communication system 1 may illuminate the user's surroundings or feet when, for example, the detected illuminance is less than a predetermined value. The communication system 1 may control the illuminated range by controlling the altitude of the unmanned aerial vehicle 10.

An example of navigation operations by the communication system 1 is now described. The communication system 1 may guide the user in the direction the user should walk on the basis of the user's destination. The communication system 1 may cause the unmanned aerial vehicle 10 to float ahead of the user and to fly so as to lead the user while staying at a predetermined distance from the user. The communication system 1 may measure the distance between the user and the unmanned aerial vehicle 10 when a distance sensor is included as the sensor 23. The communication system 1 may cause the unmanned aerial vehicle 10 to fly on the basis of the distance between the user and the unmanned aerial vehicle 10. The communication system 1 may cause the unmanned aerial vehicle 10 to fly at a different height than the user's eye level. This makes the unmanned aerial vehicle 10 less likely to block the user's field of vision. Information to guide the user may be included in information pertaining to the transportation system 100. In other words, the communication system 1 may output information pertaining to the transportation system 100 by movement of the unmanned aerial vehicle 10.

The communication system 1 may guide the user by causing the unmanned aerial vehicle 10 to float ahead of the user and causing the direction in which the user should walk to be displayed on the display 25. The communication system 1 may guide the user by displaying a map indicating the route on the display 25. When a projector is included as the display 25, the communication system 1 may guide the user by projecting a map, indicating the direction in which the user should walk or the route, on the ground ahead of the user. The communication system 1 may control the size of the projected image by controlling the altitude of the unmanned aerial vehicle 10. When an illuminance sensor is included as the sensor 23, the communication system 1 may control the brightness of the projected image on the basis of the detected illuminance.

When guiding the user, the communication system 1 may acquire safety information from the roadside device 40 or the vehicle 30. The communication system 1 may infer the direction in which the user is walking and acquire, in advance, safety information for the area located in the inferred direction. When, for example, the communication system 1 infers that the user is walking towards an area not visible to the user, the communication system 1 may acquire safety information on the area that is not visible and notify the user. This configuration can improve user safety.

The communication system 1 may transmit information related to the direction in which the user is inferred to be walking to the roadside device 40 or the vehicle 30. This configuration can further improve user safety. The information related to the direction in which the user is inferred to be walking may be included in information pertaining to the transportation system 100.

When the user has a visual impairment, or the user's field of vision is blocked by surrounding fog, haze, smoke, or the like, it may be difficult or impossible for the user to confirm the surrounding conditions visually. When it is difficult or impossible for the user to confirm the surrounding conditions visually, the communication system 1 may output audio or provide a tactile sensation to the user to guide the user. The communication system 1 may, for example, output information related to the direction in which the user should proceed or output safety information by audio on the area located in the user's direction of travel.

The communication system 1 may be tied to the user by a strap or the like. The communication system 1 may transmit vibration to the user through the strap or the like. The vibration pattern may be associated with the content of the notification for the user. The vibration pattern may, for example, be a pattern corresponding to a code representing letters, such as Morse code.

The communication system 1 may control the unmanned aerial vehicle 10 so as to pull the user through the strap or the like. The pattern in which the unmanned aerial vehicle 10 pulls the user may be associated with the content of the notification for the user. For example, the unmanned aerial vehicle 10 may notify the user of the direction to proceed by pulling the user in the horizontal direction. As another example, the unmanned aerial vehicle 10 may notify the user of safety information by pulling the user in the vertical direction. When the unmanned aerial vehicle 10 pulls the user in the vertical direction, the effect on other pedestrians, vehicles 30, or the like around the user can be reduced. When the unmanned aerial vehicle 10 flies at a higher position than the user's eye level, the communication system 1 can acquire the surrounding conditions over a larger range. The pattern in which the unmanned aerial vehicle 10 pulls the user may be associated with the content of the notification for the user in a similar or identical way to the vibration pattern.

When a strain sensor, a pressure sensor, or the like is included as the sensor 23, the communication system 1 may use the sensor 23 to detect that the unmanned aerial vehicle 10 is being pulled by the user through the strap or the like. When detecting that the unmanned aerial vehicle 10 is being pulled by the user, the communication system 1 may judge that the user has stopped or changed direction. The communication system 1 may acquire information related to the user's surrounding conditions or cause the unmanned aerial vehicle 10 to fly on the basis of the user's actions.

The communication system 1 may be configured to be capable of communication with a wearable device worn by the user. The communication system 1 may guide the user or notify the user of safety information through the wearable device. The communication system 1 may cause the wearable device to output audio or generate vibration. The wearable device may include a motion sensor or the like for detecting user movement. The communication system 1 may acquire information related to user movement from the wearable device. The wearable device may include a biological sensor or the like for detecting the user's physical condition. The communication system 1 may acquire information related to the user's physical condition from the wearable device. The communication system 1 may transmit information acquired from the wearable device to the roadside device 40, the vehicle 30, or the like, or to an external apparatus such as a server.

The communication system 1 can, for example, serve as a substitute for a seeing-eye dog or the like by guiding a visually impaired user or transmitting information on the user's physical condition to an external destination. Consequently, pedestrian safety can be improved.

An example of operations by the communication system 1 during wearing of an earphone is now described. The communication system 1 may include an earphone as the notification interface 26. The communication system 1 may transmit audio data to the earphone by wireless communication. The user may listen to content, such as music, with the earphone. This configuration allows the user to listen to content without carrying a device for playing back content. This can increase user convenience when, for example, the user is running.

The communication system 1 may control the volume of output from the earphone on the basis of the user's surrounding conditions or safety information. When, for example, the communication system 1 acquires approach information related to the user, the communication system 1 may reduce or mute the volume of output from the earphone so that the user can more easily hear surrounding sounds. The communication system 1 may output audio related to the content of a notification for the user from the earphone.

An example of coordination between user actions and the communication system 1 is now described. The communication system 1 can cause the unmanned aerial vehicle 10 to fly while following the user's steps. The communication system 1 may cause the unmanned aerial vehicle 10 to move on the basis of user actions.

For example, when the user is wearing a wristwatch-type terminal provided with a barometric pressure sensor or the like, the communication system 1 can detect if the user is raising a hand by acquiring the barometric pressure detected by the wristwatch-type terminal. The communication system 1 may cause the unmanned aerial vehicle 10 to fly at a height corresponding to the height of the user's raised hand. When the communication system 1 detects that the user has raised a hand and also that the user is approaching an intersection, a pedestrian crossing, or a road, the communication system 1 may judge that the user is about to cross the road. In this case, the communication system 1 may transmit information related to the user's intention to cross the road to the roadside device 40 or the vehicle 30. The communication system 1 may notify the vehicle 30 of the pedestrian's presence by causing the unmanned aerial vehicle 10 to fly to a position highly visible from the vehicle 30 and emitting light or the like from the notification interface 26. When a light or flash is included as the notification interface 26, the communication system 1 may cause these to emit light. The pedestrian safety can be improved by the communication system 1 transmitting information related to the pedestrian or providing notification of the pedestrian's presence.

The communication system 1 may cause the unmanned aerial vehicle 10 to fly at a position highly visible to the user for the user to see an augmented reality (AR) image displayed on the display 25. The user may wear an eyeglasses-type terminal. The eyeglasses-type terminal may detect the user's line or sight or the like. The communication system 1 may acquire information related to the user's line of sight from the eyeglasses-type terminal. The communication system 1 may control the orientation or position of the unmanned aerial vehicle 10 on the basis of the user's line of sight. The communication system 1 may control the orientation or position of the unmanned aerial vehicle 10 to allow imaging of the scenery in a direction identical or close to the user's line of sight. The communication system 1 may display, on the display 25, an AR image yielded by overlaying characters, symbols, shapes, or the like on a captured image of the scenery in the direction of the user's line of sight. This allows the user to confirm the surrounding conditions easily.

The communication system 1 may use a camera or the like to image the scenery away from the user's line of sight, such as behind or to the side of the user. The communication system 1 may combine captured images and display the result on the display 25 as an image that enlarges the user's field of vision. This allows the user to confirm the surrounding conditions more easily.

The communication system 1 may cause the unmanned aerial vehicle 10 to fly so as to image the scenery surrounding the user from a higher position than the user's eye level. The user can more easily confirm the surrounding conditions by viewing an image from a higher position than the user's eye level.

The user can easily confirm the surrounding conditions by the communication system 1 displaying an AR image on the display 25. Consequently, the safety of the user as a pedestrian can be improved.

An example of coordination between a traffic light and the communication system 1 is now described. When a pedestrian is close to an intersection with a traffic light, the roadside device 40 may monitor whether the pedestrian is about to cross the pedestrian crossing on the basis of information related to the state of the traffic light. The information related to the state of the traffic light includes information related to whether the traffic light is red, green, or yellow, or whether the traffic light is flashing. The area of the pedestrian crossing at the intersection may be classified as a first area, in which crossing is prohibited, and a second area, in which crossing is allowed, on the basis of the information related to the state of the traffic light. The area of the pedestrian crossing may be classified as the first area when the traffic light is red, yellow, or flashing green. The area of the pedestrian crossing may be classified as the second area when the traffic light is green.

The roadside device 40 may monitor the pedestrian's movement and judge whether the pedestrian is about to enter the first area. When a pedestrian judged to be about to enter the first area is the user of the communication system 1, the roadside device 40 may transmit information related to how the user is about to enter the first area to the communication system 1. On the basis of information acquired from the roadside device 40, the communication system 1 may cause the unmanned aerial vehicle 10 to fly ahead of or in front of the user to block the user from entering the first area. When a light or flash is included as the notification interface 26, the communication system 1 may cause the unmanned aerial vehicle 10 to float at a position highly visible to the user and turn the light or flash on. In other words, the communication system 1 may notify the user that he is about to enter the first area.

The communication system 1 may acquire information related to the state of the traffic light from the roadside device 40. The communication system 1 may judge whether the user, who is a pedestrian, is about to enter the first area on the basis of the information related to the state of the traffic light. When judging that the user is about to enter the first area, the communication system 1 may notify the user that he is about to enter the first area.

Having the communication system 1 notify the user that he is about to enter the first area allows the user to realize more easily that he is about to enter the first area. This can improve user safety.

When detecting that a pedestrian is about to enter the first area, the roadside device 40 may transmit information related to the pedestrian to the vehicle 30. When detecting that the user, who is a pedestrian, is about to enter the first area, the communication system 1 may transmit information related to the pedestrian to the vehicle 30 directly or via the roadside device 40. This makes the pedestrian more noticeable from the vehicle 30, improving pedestrian safety.

When detecting that a pedestrian is about to enter the second area, the roadside device 40 may transmit information related to the pedestrian to the vehicle 30. When detecting that the user, who is a pedestrian, is about to enter the second area, the communication system 1 may transmit information related to the pedestrian to the vehicle 30 directly or via the roadside device 40. This makes the pedestrian more noticeable from a vehicle 30 that is about to turn right or left at the intersection. By acquiring information before the pedestrian starts to enter the second area, the vehicle 30 can avoid the pedestrian more easily, improving pedestrian safety.

An example of operations by the communication system 1 when detecting sound is now described. The communication system 1 may detect sound around the user. On the basis of the detected surrounding sound, the communication system 1 may, for example, recognize that a vehicle 30 is approaching. The vehicle 30 may be an automobile or a train. The communication system 1 may recognize that the vehicle 30 is approaching by detecting moving vehicle noise of the vehicle 30. The communication system 1 may recognize that a train is approaching by detecting the warning sound of a railway crossing. In other words, the communication system 1 may acquire approach information of the vehicle 30 on the basis of detected surrounding sound. The communication system 1 may notify the user of the approach information of the vehicle 30. The communication system 1 may notify the user of the approach information by causing the unmanned aerial vehicle 10 to fly ahead of or in front of the user. When a light or flash is included as the notification interface 26, the communication system 1 may cause the unmanned aerial vehicle 10 to float at a position highly visible to the user and turn the light or flash on. This allows the user to learn information based on surrounding sound even when surrounding sound is difficult or impossible for the user to hear, thereby improving the safety of the user as a pedestrian.

The communication system 1 may recognize the approach of the train or the like from the result of detecting surrounding conditions with a different configuration, such as a camera, as well as the result of detecting sound.

The communication system 1 may notify the user of various types of information, such as information pertaining to the transportation system 100, safety information, and approach information. The communication system 1 may determine the method for notifying the user automatically or by user setting. The communication system 1 may select the information of which to notify the user automatically or by user setting.

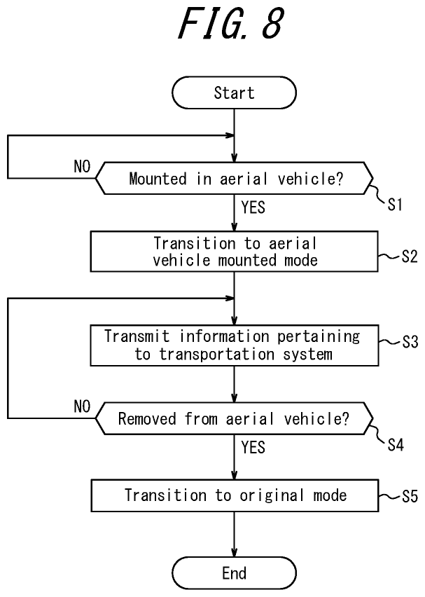

An example of a flowchart for the communication system 1 is now described. The communication system 1 includes the unmanned aerial vehicle 10 and the communication terminal 20. When the communication terminal 20 is mounted on the unmanned aerial vehicle 10, the terminal controller 21 of the communication terminal 20 can execute the procedures in the example flowchart in FIG. 8.

The terminal controller 21 judges whether the communication terminal 20 is mounted on the unmanned aerial vehicle 10 (step S). The terminal controller 21 may detect electrically that the communication terminal 20 is mounted on the unmanned aerial vehicle 10. The terminal controller 21 may use the detection result to determine whether the communication terminal 20 is mounted on the unmanned aerial vehicle 10.

When the communication terminal 20 is not mounted on the unmanned aerial vehicle 10 (step S1: NO), the terminal controller 21 returns to the procedure in step S1.

When the communication terminal 20 is mounted on the unmanned aerial vehicle 10 (step S1: YES), the terminal controller 21 transitions to the aerial vehicle mounted mode (step S2).

The terminal controller 21 transmits information pertaining to the transportation system 100 in which the user of the communication terminal 20 is included to the unmanned aerial vehicle 10 (step S3). The terminal controller 21 may transmit information pertaining to the transportation system 100 to the unmanned aerial vehicle 10 even when the communication terminal 20 is not mounted on the unmanned aerial vehicle 10. The terminal controller 21 may transmit information pertaining to the transportation system 100 to the vehicle 30, the roadside device 40, or the like.

The terminal controller 21 judges whether the communication terminal 20 has been removed from the unmanned aerial vehicle 10 (step S4). The terminal controller 21 may detect electrically that the communication terminal 20 has been removed from the unmanned aerial vehicle 10. The terminal controller 21 may use the detection result to determine whether the communication terminal 20 has been removed from the unmanned aerial vehicle 10.

When the communication terminal 20 has not been removed from the unmanned aerial vehicle 10 (step S4: NO), the terminal controller 21 returns to the procedure in step S3.

When the communication terminal 20 has been removed from the unmanned aerial vehicle 10 (step S4: YES), the terminal controller 21 transitions to the original mode before transitioning to the aerial vehicle mounted mode (step S5). After step S5, the terminal controller 21 terminates the procedure of the flowchart in FIG. 8.

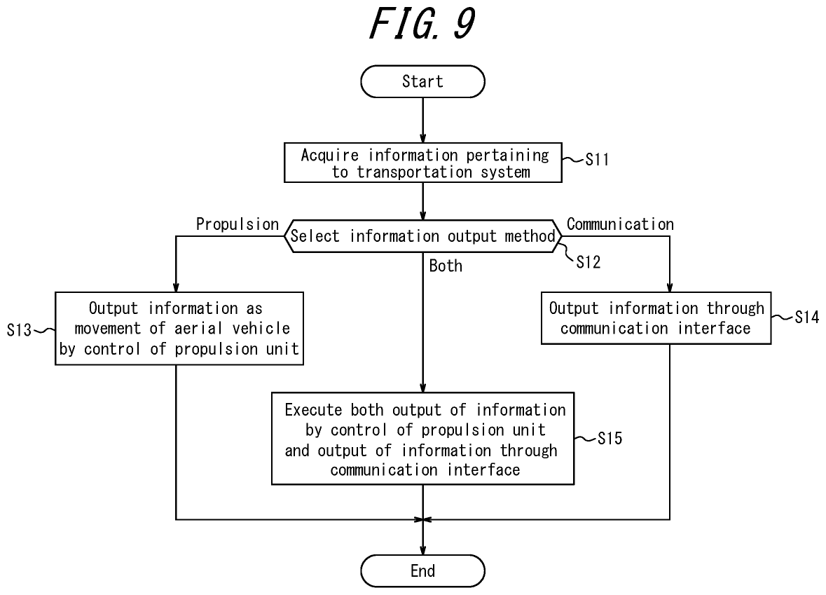

The aerial vehicle controller 11 of the unmanned aerial vehicle 10 can execute the procedures in the example flowchart in FIG. 9.

The aerial vehicle controller 11 acquires information pertaining to the transportation system 100 in which the user of the communication terminal 20 is included from the communication terminal 20 (step S11).

To output information pertaining to the transportation system 100, the aerial vehicle controller 11 selects at least one of controlling the propulsion unit 13 and transmitting the information through the vehicle communication interface 12 (step S12).

When outputting information pertaining to the transportation system 100 by controlling the propulsion unit 13 is selected (step S12: propulsion), the aerial vehicle controller 11 controls the propulsion unit 13 to output information pertaining to the transportation system 100 by movement of the unmanned aerial vehicle 10 (step S13). After step S13, the aerial vehicle controller 11 terminates the procedure of the flowchart in FIG. 9.

When outputting information pertaining to the transportation system 100 through the aerial vehicle communication interface 12 is selected (step S12: communication), the aerial vehicle controller 11 outputs information pertaining to the transportation system 100 by transmitting the information from the aerial vehicle communication interface 12 (step S14). The aerial vehicle communication interface 12 may output the information pertaining to the transportation system 100 to the roadside device 40, the vehicle 30, or the like. The aerial vehicle communication interface 12 may output the information pertaining to the transportation system 100 to an external apparatus such as a server. After step S14, the aerial vehicle controller 11 terminates the procedure of the flowchart in FIG. 9.

When outputting information pertaining to the transportation system 100 with both the propulsion unit 13 and the aerial vehicle communication interface 12 is selected (step S12: both), the aerial vehicle controller 11 executes the procedure of step S13 and the procedure of step S14 together (step S15). After step S15, the aerial vehicle controller 11 terminates the procedure of the flowchart in FIG. 9.

By including the unmanned aerial vehicle 10 and the communication terminal 20, the communication system 1 according to the present disclosure can output information pertaining to the transportation system 100. This can improve the safety of the transportation system 100.

The communication system 1 according to the present disclosure outputs information pertaining to the transportation system 100 as movement of the unmanned aerial vehicle 10, thereby allowing the user to notice the information easily. This can improve user safety.

The communication system 1 according to the present disclosure performs control for the user to see the movement of the unmanned aerial vehicle 10, thereby allowing the user to notice the information easily. This can improve user safety.

The communication system 1 according to the present disclosure outputs information pertaining to the transportation system 100 to other elements in the transportation system 100, which can improve safety of the transportation system 100.

By the communication terminal 20 being mounted on the unmanned aerial vehicle 10, the communication system 1 according to the present disclosure allows use of the communication terminal 20 without the user of the communication terminal 20 holding or wearing the communication terminal 20. This can improve user convenience.

The vehicle 30 in the present disclosure may encompass automobiles and industrial vehicles. Automobiles include, but are not limited to, passenger vehicles, trucks, buses, motorcycles, trolley buses, and the like. The vehicle 30 may encompass man-powered vehicles.

Although an embodiment of the present disclosure has been described through drawings and examples, it is to be noted that various changes and modifications will be apparent to those skilled in the art based on the present disclosure. Therefore, such changes and modifications are to be understood as included within the scope of the present disclosure. For example, the functions or the like included in the various components or steps may be reordered in any logically consistent way. Furthermore, components or steps may be combined into one or divided. While an embodiment of the present disclosure has been described focusing on apparatuses, the present disclosure may also be embodied as a method that includes steps performed by the components of an apparatus. The present disclosure may also be embodied as a method executed by a processor provided in an apparatus, as a program, or as a non-transitory computer-readable medium having a program recorded thereon. Such embodiments are also to be understood as encompassed within the scope of the present disclosure.

The references to “first”, “second”, and the like in the present disclosure are identifiers for distinguishing between elements. The numbers of elements distinguished by references to “first”, “second”, and the like in the present disclosure may be switched. For example, the identifiers “first” and “second” of the first area and the second area may be switched. Identifiers are switched simultaneously, and the elements are still distinguished between after identifiers are switched. The identifiers may be removed. Elements from which the identifiers are removed are distinguished by their reference sign. Identifiers in the present disclosure, such as “first” and “second”, may not be used in isolation as an interpretation of the order of elements or as the basis for the existence of the identifier with a lower number.

1. An aerial vehicle comprising:
at least one communicator; and
a controller configured to cause the at least one communicator to transmit first information pertaining to a transportation system to at least one of a vehicle and a roadside device by controlling the at least one communicator.

2. The aerial vehicle of claim 1, wherein
the at least one communicator is configured to receive a scenery image containing a pedestrian from the roadside device, and
the controller is further configured to:
determine whether the pedestrian is located at a predetermined location associated with a road based on the scenery image, and
control the at least one communicator to transmit the first information to the vehicle when the controller determines the pedestrian is located at the predetermined location.

3. The aerial vehicle of claim 1, wherein
the at least one communicator is configured to receive a scenery image containing at least a pedestrian and the vehicle from the roadside device, and
the controller is further configured to:
determine whether the pedestrian and the vehicle have reached a predetermined positional relationship based on the scenery image, and
control the at least one communicator to transmit the first information to the vehicle when the controller determines the pedestrian and the vehicle have reached the predetermined positional relationship.

4. The aerial vehicle of claim 1, further comprising:
an imaging device configured to acquire a scenery image containing a pedestrian, wherein
the controller is further configured to:
determine whether the pedestrian is located at a predetermined location associated with a road based on the scenery image, and
control the at least one communicator to transmit the first information to the vehicle when the controller determines the pedestrian is located at the predetermined location.

5. The aerial vehicle of claim 1, further comprising:
an imaging device configured to acquire a scenery image containing at least a pedestrian and the vehicle, wherein
the controller is further configured to:
determine whether the pedestrian and the vehicle have reached a predetermined positional relationship based on the scenery image, and
control the at least one communicator to transmit the first information to the vehicle when the controller determines the pedestrian and the vehicle have reached the predetermined positional relationship.

6. The aerial vehicle of claim 1, wherein
the at least one communicator is configured to receive second information related to traffic lights from the roadside device, and
the controller is configured to control the at least one communicator to transmit the first information to the vehicle based on the second information.

7. The aerial vehicle of claim 1, further comprising:
at least one position sensor configured to acquire third information related to a first position of a pedestrian and fourth information related to a second position of the aerial vehicle; and
at least one propeller rotated by a motor for flying, wherein
the controller is further configured to:
specify the first position based on the third information and the second position based on the fourth information,
control the at least one propeller so that the first position and the second position maintain a predetermined relationship, and
control the at least one communicator to transmit the first information to the at least one of the vehicle and the roadside device when the second position is located in a predetermined area.
